(19) United States
(12) Patent Application Publication
(10) Pub. No.: US 2023/0290264 A1
(43) Pub. Date: Sep. 14, 2023

(54) Interactive Phonics Board

(71) Applicant: Jennifer Renee Kasino Dezelle, Round Rock, TX (US)

(72) Inventor: Jennifer Renee Kasino Dezelle, Round Rock, TX (US)

(21) Appl. No.: 18/183,088

(22) Filed: Mar. 13, 2023

Related U.S. Application Data
(60) Provisional application No. 63/303,137, filed on Mar. 14, 2022.

(51) Int. Cl. G09B 17/00; G09B 1/08; B43L 1/00

(52) U.S. Cl. CPC G09B 17/00; G09B 1/08; B43L 1/008

(57) ABSTRACT

Modern research in the science of reading has shed light on how the human brain learns to read and write. Scientists now understand reading is not based on visual memory, but a process of orthographic mapping where students connect the sounds and meaning of a word to the sequence of letters that spell the word. A teaching tool is presented that utilizes phoneme and grapheme manipulatives designed to be arranged by students to build words in a word building area. Instructional grid lines promote orthographic mapping, aiding the development of student's understanding of phoneme-grapheme correspondence. A durable, zippable enclosure allows for portability and safe keeping. A storage compartment for grapheme manipulatives that have not been introduced yet, along with a phoneme and grapheme presentation areas help students stay organized without being overwhelmed. Gradually introducing new graphemes promotes the systematic and cumulative practice recommended by modern research in literacy.

### CROSS-REFERENCE TO RELATED APPLICATIONS

This application claims priority to U.S. Provisional Patent Application No. 63/303,137 filed on Mar. 14, 2022, entitled “Interactive Phonics Board,” the contents of which are hereby incorporated herein by reference.

### BACKGROUND OF THE INVENTION

Learning to read and write is an essential component of preparing for adulthood in modern society. In 1986, Gough & Tunmer defined the Simple View of Reading model, which explains that individuals need to have both strong word recognition and strong language comprehension skills in order to be effective readers. Many decades of research have concluded that unlike oral language comprehension skills, children do not develop written word recognition skills naturally. Learning these skills requires instruction in several sub-topics, which include phonemic awareness, sound-letter correspondence rules, sight word recognition and structural analysis of complex words. These skills typically develop in phases and advancements through the phases are facilitated by direct instruction.

In 1995, Dr. Ehri defined the phases of reading development as pre-alphabetic, partial alphabetic, full alphabetic, and consolidated alphabetic. In order to reach automaticity in the consolidated alphabetic phase, Ehri explains that students need to understand the regularity of the writing system, beginning with grapheme-phoneme relations.

Nancy Young, B.A., M Ed. found the majority of the population requires explicit, systematic and sequential instruction in phonics in order for the instruction to be effective and for students to gain this understanding of grapheme-phoneme relations. The report issued by The National Reading Panel (2000) further emphasized the need for systematic phonics instruction.

Explicit, systematic instruction in phonics requires that graphemes are introduced gradually. A first set of graphemes should be presented and mastered before moving on to a new grapheme or set of graphemes, which in turn, should be well understood before progressing to include additional graphemes, and so on. Frustration levels can easily be reached when students are provided too much information at once, furthering the need for systematic and explicit instruction. Many teaching tools do not provide a convenient way to store and conceal graphemes manipulatives that have not yet been introduced, or they have pre-printed graphemes on the surfaces that are presented to students. This excess visual stress can be overwhelming to students and negatively impact performance and advancement.

Although foundational literacy instruction may be beneficial to students of any age when remedial support is required, the ideal age to provide instruction in reading has been identified as 5-8 years old. Children in this age group have a very limited ability to think in abstract terms. They benefit from instruction using concrete materials. Hands-on manipulatives are commonplace in math instruction, but are less commonly used in language instruction.

Class sizes at this age typically range from 16-25 students per teacher. Ensuring all students within the class have opportunities to practice and apply new learning can be difficult. By providing concrete materials and clearly defined guides to show and describe where students should build words, teachers are enabled to instruct students more precisely and students are more likely to understand instructions.

Many existing toolkits lack portability and are cumbersome to transport between home and school. Many are not capable of containing and securing all removable parts to prevent accidental loss or damage. This can be especially problematic when pieces are magnetic and may stick to other students' toolkits or nearby furniture. Furthermore, many existing kits present storage challenges. For example, due to their size or shape, some toolkits may not easily fit in student desks. Classroom storage space is often limited, so student materials need to be stored in a compact manner.

While tools in the art have attempted to solve these problems, there remains a need for a literacy development tool that provides concrete support for grapheme-phoneme relations, and to do so in an engaging and interactive way. The apparatus herein described is directed toward meeting these needs. The kit contains all required materials in a portable enclosure designed to be used by students and teachers and supports students across multiple phases of reading and spelling development.

### SUMMARY OF THE INVENTION

To address the aforementioned problems, a kit, which is the preferred embodiment of the interactive phonics board, is taught. The kit comprises a compact enclosure containing tools needed to help students understand and build phoneme to grapheme correspondence. This mapping of speech to print helps students understand that there is a systematic relationship between letters and sounds, also known as the alphabetic principle. The case opens to reveal a grapheme presentation area, which comprises a grid of 26 pre-printed circles, on a top whiteboard and a phoneme presentation area, which guides the placement of phoneme manipulatives when not being actively used in a word building activity, an interactive word building area, which resembles a doubled Elkonin grid and maps phoneme manipulatives to grapheme manipulatives, a blending line, which appears as an arrow pointing to the right, and a writing grid, which consists of solid and dashed lines, on a bottom whiteboard.

An object of the preferred embodiment is to enable teachers to introduce students to graphemes in a systematic and explicit way, without visually overwhelming them with graphemes that have not yet been introduced. For example, a teacher may utilize the kit's storage compartment to conceal all the grapheme manipulatives of a student's kit such that when it is first opened, no graphemes are presented. The kit allows the teacher to decide which graphemes will be introduced and the order in which to introduce them. As teachers introduce more and more graphemes, learners are able to manipulate the tiles to build words. For example, when a student knows the sounds /a/ and /t/ correspond to the letters ‘a’ and ‘t’, they can build the word ‘at’. In 2002, Dr. Martin Kozloff pointed out that when children learn the sounds of 10 letters, they can build 350 three-sound words, 4,320 four-sound words, and 21,650 five-sound words. Because of the design of the kit the student does not need to guess at whole words, but is instead encouraged to map phonemes to graphemes within the orthographic system in a systematic way.

An object of the preferred embodiment is to facilitate the understanding that there is a systematic relationship between letters and sounds. Students use the tool by first counting the sounds they hear within a given word, then moving the phoneme manipulatives onto the phoneme word building area using one phoneme manipulative for each sound. Next, students manipulate corresponding grapheme manipulatives to match each phoneme manipulative within the given word onto the grapheme word building area. The arrangement of the interactive word building area supports the understanding of the one-to-one correspondence between phonemes and graphemes. This practice is especially helpful when students see that some graphemes are multi-letter graphemes, or graphemes that contain more than one letter. For example, the letters ‘ch’ map to the single sound /ch/. This mapping of speech to print unlocks the alphabetic principle for learners, moving them from the pre-alphabetic phase into partial alphabetic and full alphabetic phases.

An object of the preferred embodiment is to support literacy development for students who cannot yet write. The kit provides students with concrete objects that they can manipulate to engage them in meaningful word building activities even before they can write. Typically students ages 5-8 are early-emergent or emergent writers and lack the automaticity with writing required for remembering graphemes without visual aids. Allowing children access to hands-on materials, or manipulatives, that have graphemes already printed helps to keep them engaged in their learning. The learners' interest in the lesson remains high because the tool provides a multisensory and interactive approach to instruction and practice sessions, while keeping frustrations about writing at bay. When students are asked to write a word, the manipulatives provide a visual reminder of the graphemes. Mistakes can easily be erased, just like using a pencil.

An object of the preferred embodiment is to help transition students to the full alphabetic phase. Students may use their fingers and follow along the blending line to remind them of the direction to blend the sounds together. Manipulatives can also be moved to this line and pushed together to help students conceptualize this component of the full alphabetic phase in a concrete way.

An object of the preferred embodiment is to make lessons engaging. Students can work through word chains, an instructional practice where each word differs from the next by one phoneme. The tool can also be used as a game so the student needs to find out the new word based on the change. Children may play this game with each other to build words. By using the word chaining technique, multiple opportunities for practice can be presented quickly, helping students more efficiently and effectively build the brain pathways required to read.

An object of the preferred embodiment is to address the needs of students as they progress through the reading phases. Word chains can progressively become more difficult, moving from simple vowel consonant (VC) words, to CVC words, to CCVC words and so on. Whereas Elkonin boxes are typically depicted with three boxes, the kit depicts 5 pre-printed box outlines to represent five phoneme word building placeholders and another 5 pre-printed box outlines to represent five grapheme word building placeholders in order to support longer target words.

An object of the preferred embodiment is to stay relevant and useful as students progress to more challenging phonics skills. For example, as students move on to longer and more challenging words, each longer target word can be broken down into syllables. Then, students can use the interactive word building area to build and write each syllable in the target word, one at a time, to ultimately spell the entire word. As another example, the phoneme word building area can be used for marking words, a strategy where teachers use diacritical marks to make pronunciation easier for students.

An object of the preferred embodiment is the portability of the kit. Teachers may allow students to store the kits in their own cubbies or desks. Kits can easily be transferred between school and home. The magnetic properties of the manipulatives and boards prevent disturbances to the state of the student's work and allow for students to use the manipulatives on the boards when they are oriented vertically, facilitate minimal preparation time between lessons. Lessons can occur at student desks, on the carpet, or at small group tables.

An object of the preferred embodiment is the ability to withstand typical wear and tear. Some toolkits in the known art may provide grapheme manipulatives made of paper, cardstock, cardboard or a laminated version of these materials. Oftentimes, these grapheme manipulatives are created through the laborious efforts of teachers. However, manipulatives made of such materials typically become damaged quickly with repeated use in the classroom, and teachers frequently find themselves spending more and more time maintaining and replacing tools, leaving less time for lesson planning and student instruction.

An object of the preferred embodiment is to ensure appropriate practice. Because each learner in a classroom can work on their own kit, adjusting the available graphemes as they advance, the teacher can individualize the lesson plans to meet the needs of learners without needing to reference additional notes on the student. Guest educators can also help support the student and practice with the graphemes available, with the understanding of which graphemes are appropriate for the student.

It should be appreciated that while prior art has attempted to address some of these objects, there still exists a need for more comprehensive solutions.

### BRIEF DESCRIPTION OF DRAWINGS

FIG. 1 is a drawing depicting a perspective open front view of the preferred embodiment.

FIG. 2 is a drawing depicting a top perspective view of the preferred embodiment with the storage compartment in an open state.

FIG. 3 is black and white photograph depicting a front elevation view of the preferred embodiment when open and in use.

FIG. 4 is a black and white photograph depicting a front elevation view of the preferred embodiment when open.

FIG. 5 is a black and white photograph depicting an oblique view of the preferred embodiment when the enclosure is in a closed state.

FIG. 6 is a black and white photograph depicting a perspective front view of the preferred embodiment

### DETAILED DESCRIPTION OF THE DRAWINGS

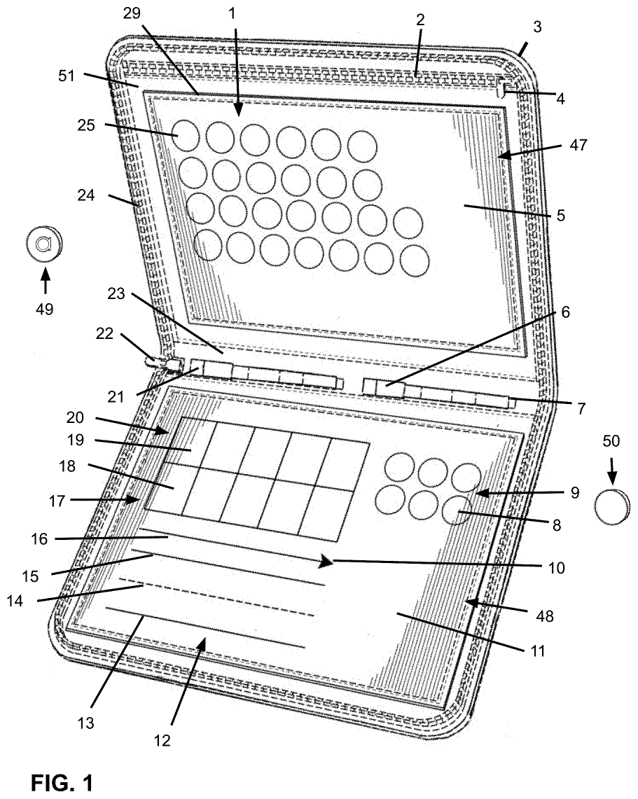

FIG. 1 illustrates the primary components of the preferred embodiment of the interactive phonics board, hereafter referred to as the kit. An example of a grapheme manipulative 49 displaying the letter “a” and an example of a phoneme manipulative 50 are shown. The preferred embodiment comprises a set of graphemes manipulatives and a set of phoneme manipulatives. Grapheme manipulatives are used to represent graphemes and generally display the letters that compose the grapheme with their shape or with printed ink, elevations, embossments, depressions or other distinctive markings. Phoneme manipulatives are used to represent phonemes, or distinct units of sounds that make up words in spoken language. Phoneme manipulatives may be uniform or may bear distinctive features, such as color, shape or texture to represent that different phonemes make different sounds or to make the kit more appealing and engaging. In the preferred embodiment, both grapheme manipulatives and phoneme manipulatives share a set of common characteristics and may be referred to simply as manipulatives when the context applies to both types. It should be appreciated that manipulatives could come in many different forms.

The kit further comprises a semi-rigid enclosure 3 that contains a top whiteboard 47 and a bottom whiteboard 48, both of which are embedded in a backing material 51 which may be made of leather, PU leather, cardboard, plastic, metal, wood or other durable materials that can be sewn, glued, stapled, nailed, tacked or otherwise attached to the whiteboards as depicted by the seam 29 and serve as an interconnect to the enclosure. In other embodiments, a single whiteboard could be used or more than two whiteboards could be used. In other embodiments, any whiteboard may be substituted with another type of board, including, but not limited to, boards made of, or a combination of, laminated paper, cardboard, plastic, metal, foam, fabric, desktop surfaces or similar materials that might be used in the construction of a game board that would support playing a game such as chess. Boards may be made with or backed with materials to which magnets are attracted, or ferromagnetic materials, such as a thin, backing sheet of steel. The enclosure 3 is connected to an enclosing zipper track 24 so that the kit can be folded at the spine 23 and zipped up with an enclosing zipper 22 for storage or transport.

The top whiteboard 47 comprises a top flexible work area 5 and a grapheme manipulative presentation area 1, further comprising an arrangement of grapheme presentation placeholders 25, each indicated with perceptible delineations which are illustrated in the preferred embodiment by pre-printed circle outlines. A flexible work area should be capable of containing a rectangle with an area of 4 square inches without colliding with other designated areas of the board.

The bottom whiteboard 48 comprises a phoneme manipulative presentation area 9 comprising a set of phoneme presentation placeholders 8 with perceptible delineations, a bottom flexible work area 11 and an interactive word building area 12, which further comprises an area designed to promote orthographic mapping illustrated in the preferred embodiment as a top row representing the phoneme word building area 20 stacked upon a bottom row representing the grapheme word building area 17. The interactive word building area 12 also comprises a blending line 16 with an arrowhead 10 to indicate the direction in which sounds should be blended and a writing line comprising a solid top line 15, a dashed middle line 14 and a solid bottom line 13 to enable learners to practice writing the words they build.

Regarding the interactive word building area 12, it should be noted that, in the preferred embodiment, the phoneme word building area 20 is characterized by perceptibly delineated phoneme word building placeholders 19, each of which indicates a unique position for one and only one phoneme manipulative. Likewise, the grapheme word building area 17 is characterized by perceptibly delineated grapheme word building placeholders 18, each of which indicates a unique position for one and only one grapheme manipulative. The phoneme word building area 20 and grapheme word building area 17 are arranged such that there is a clear, one-to-one mapping between each phoneme word building placeholder and the associated grapheme word building placeholder. To exemplify this concept further, the phoneme word building placeholder 19 is clearly associated with the grapheme word building placeholder 18 by their alignment in a column, and so when the user places a respective phoneme manipulative and grapheme manipulative into these positions, an association is made between the underlying phoneme represented by the phoneme manipulative and the underlying grapheme represented by the grapheme manipulative. It should be appreciated that other arrangements are contemplated that achieve the same one-to-one mapping including arrangements where space, text or images are inserted between rows or columns or the like in other embodiments. Furthermore, it should be appreciated that phoneme word building placeholders 19, grapheme word building placeholders 18, phoneme presentation placeholders 8 and grapheme presentation placeholders 25 may be delineated through the use of different colors, shapes, outlines, imprints, elevations or the like in other embodiments.

The kit also comprises a set of two markers, one of which is shown on the right 7 and another on the left. The right marker's removable cap 6 is indicated and the left marker has a similar cap. The left marker has a dry-erase eraser 21 embedded in and protruding out its cap and the right marker has a similar dry-erase eraser. This configuration has the advantage of allowing users to hold the marker like a pencil to write and turn it around to erase markings. It should be noted that any combination of writing tool and eraser which can easily mark and erase the writing surface is contemplated. A storage zipper 2 is used to unzip a storage zipper track 4.

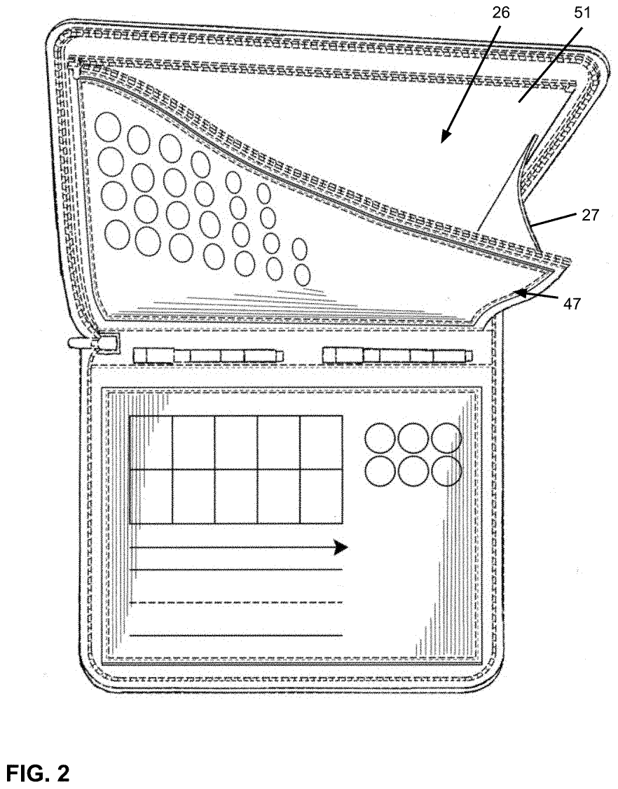

Referring to FIG. 2, the kit further comprises a storage compartment 26 which is illustrated in an opened state to demonstrate that it receives phoneme manipulatives or grapheme manipulatives for storage or allows users access to previously stored phoneme manipulatives or grapheme manipulatives. This built-in storage solution ensures that the removable pieces of the kit are less likely to be separated from the kit or mixed up with another kit, and helps ensure that removable pieces will be available for use when they are needed. In the preferred embodiment, the top whiteboard 47 is semi-pliable and connected to a semi-rigid outer cover 51 by a pliable fabric storage barrier 27 that keeps stored contents contained. Other storage solutions, such as a pouch, are contemplated as suitable substitutes to achieve the same end. The kit's storage solution provides that stored manipulatives are not visible to users and enhances focus on and does not distract away from the manipulatives that have been introduced and presented for the lesson at hand.

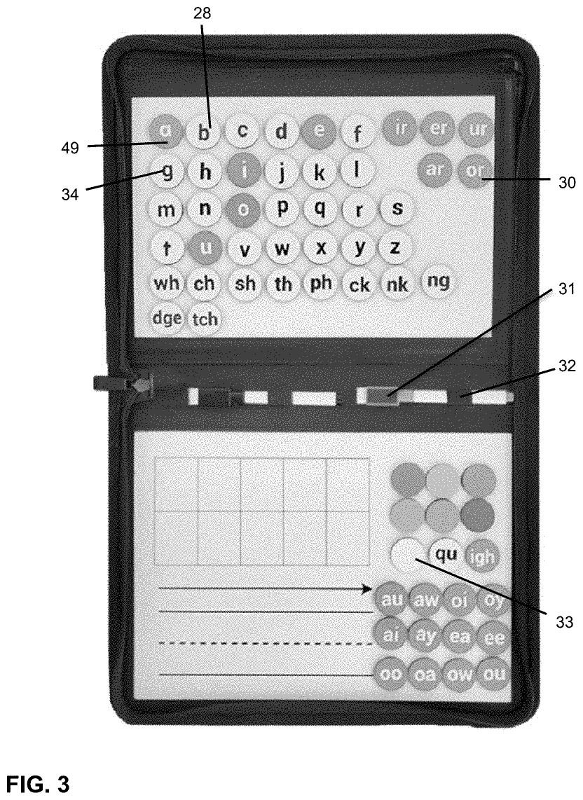

Referring to FIG. 3, a black and white photograph illustrates the configuration of grapheme manipulatives “a” through “z” being presented in the grapheme manipulative presentation area and additional grapheme manipulatives being presented in the top and bottom flexible areas of the whiteboards. Note that the “or” grapheme manipulative 30 contains two letters and that grapheme manipulatives may display one or more letters. There is also a blank grapheme manipulative 33 provided so that users may write custom graphemes or other markings. Additionally, note that the “a” grapheme manipulative 49 uses white light-colored font on a darker background and the “b” grapheme manipulative 28 uses dark-colored font on a light background. In certain embodiments, grapheme manipulatives that include vowels are colored differently than grapheme manipulatives that only include consonants. Printed lower-case alphabetic characters 34 are clearly displayed in a large font on grapheme manipulatives. Upper case characters are also contemplated, as are characters from other languages including, but not limited to, Spanish and French. An embedded eraser cap magnet 31 is situated in the eraser cap to allow the eraser to stick to the whiteboard. Markers can also be maintained in elastic marker sleeves 32.

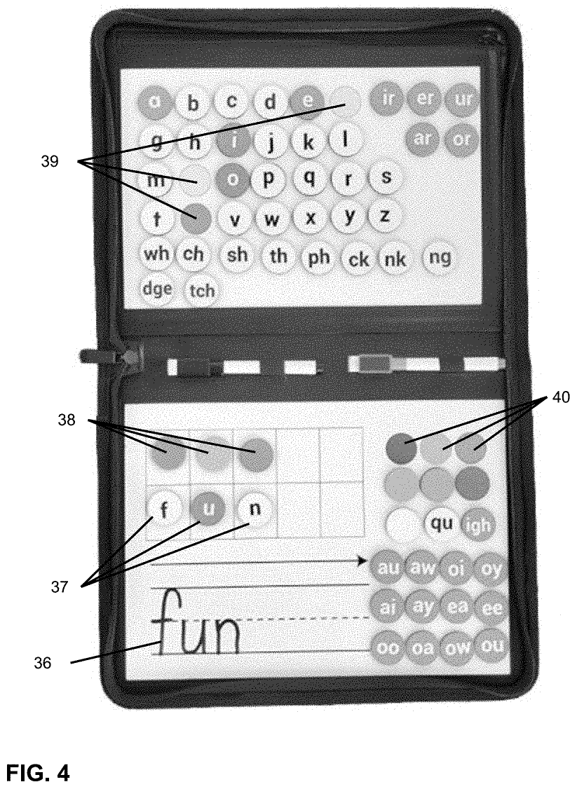

FIG. 4. depicts the use of the word building area. Three phoneme manipulatives 38 have been moved from the top three phoneme presentation placeholders 40 and onto the first three phoneme word building placeholders. The grapheme manipulatives which represent the letters “f”, “u” and “n” 37 have been moved from their respective grapheme presentation placeholders 39 and placed directly underneath their associated phoneme manipulatives and populate the first three grapheme word building placeholders. The handwriting 36 spelling the word “fun” illustrates the use of the writing line.

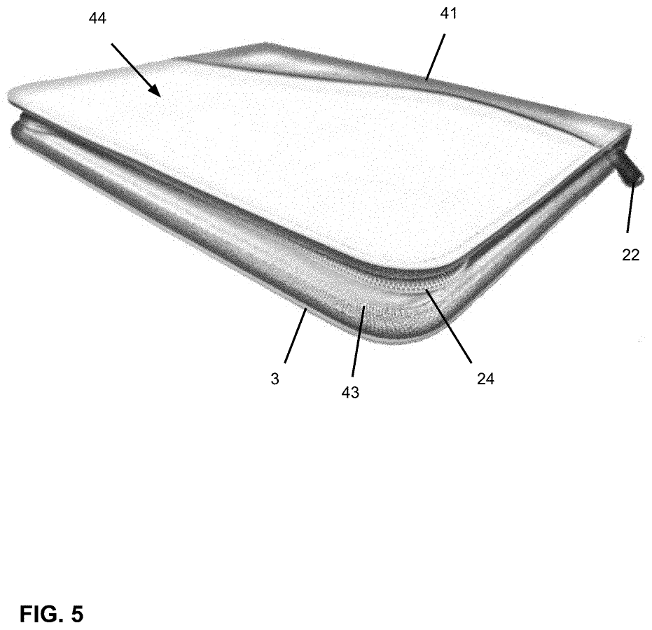

FIG. 5 shows the kit when it is closed and ready for transport or storage. A durable fabric interconnect 43 connects the enclosure 3 to the enclosing zipper track 24 which is zipped and unzipped by the enclosing zipper 22. The outer cover 44, which should preferably be durable to protect the enclosed contents, and the spine of the outer cover 41 are also indicated.

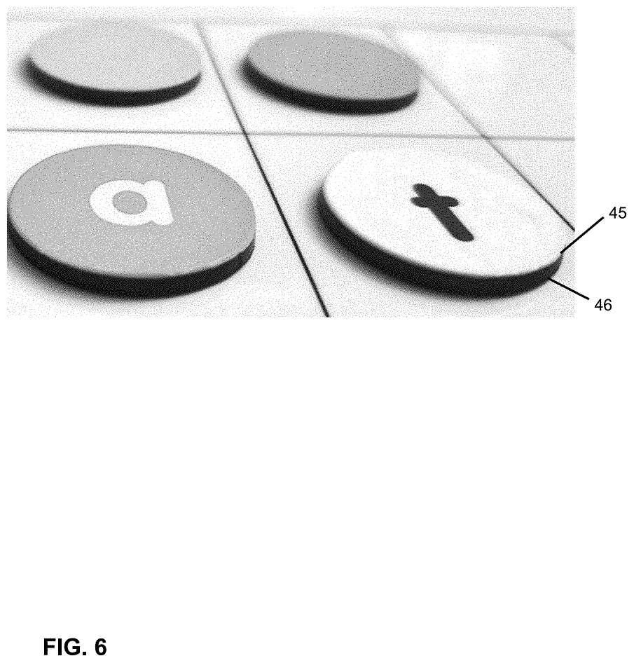

FIG. 6 provides a close up view of two grapheme manipulatives on the bottom and two phoneme manipulatives on the top. In the preferred embodiment, the both types of manipulative are constructed of a thin, finished paper skin 45 glued to a thick magnetic substrate 46 and cut in the shape of a thick coin. The thickness is important as it allows the user to more easily grasp the manipulative. In the preferred embodiment, the phoneme manipulatives are uniquely colored to distinguish themselves when compared to other phoneme manipulatives and thus represent different sounds corresponding to different phonemes.

### DETAILED DESCRIPTION OF THE INVENTION

The preferred embodiment of the interactive phonics board is a leather portfolio with a zipper that ensures all materials remain inside the kit. When opened, the kit reveals working space and presentation space. The working space contains several features that support student learning. The first is an Elkonin box grid that has been extended and doubled creating two rows with five boxes each to show students how sounds are connected to graphemes in written language. Below this grid is an arrow spanning the width of the box grid and pointing left to right as a reminder to blend sounds together in this direction. Below this is a writing guide that provides students with the opportunity to practice writing the words that they build. There are also colored dots on this board to help students keep their sound tiles organized. Additional blank space is available for grapheme tiles that the student is currently working on. In the middle of the kit there are two elastic bands to hold white board markers. The markers include caps with erasers, mimicking pencils with erasers on the ends. The storage space of the kit also contains a grid for helping students organize their graphemes. This grid has 26 circles, one for each letter of the alphabet. The circles are not marked, to ensure students only see graphemes that have been explicitly taught, but there are 5 shaded red to mark placement of the vowels, which help orient students when populating the abc grid. The grid is broken into four lines such that each letter at the end of a line is f, l, s, or z, the letters that are doubled when immediately following short vowels at the end of a one syllable word. A zipper on this side opens to a storage compartment that allows for the storage of any graphemes tiles that have yet to be introduced to ensure that they do not interfere with the current lesson. Furthermore, the zipped storage compartment ensures that tiles are not easily lost and they do not migrate to the other areas of the kit, such as the manipulative presentation or word building areas during transport.

When using the kit with a beginning reader, the teacher would follow a scope and sequence of their choice to introduce new graphemes. For example, a program may introduce the letters ‘s’, ‘a’, ‘t’, and ‘m’ at the beginning of the school year. This would allow the student to build words such as “at”, “sat”, “mat”, and “Sam”. Mapping words and discussing the grapheme-phoneme correspondence helps students to see the way proficient readers find meaning from the strings of symbols in text. Practice with this strategy helps move readers into Ehri's Full Alphabetic Stage for reading and Read and Henderson's Phonetic Stage for spelling, typically obtained in late Kindergarten or early first grade. Students become motivated to learn more graphemes in order to have access to more words. With the addition of more graphemes, like ‘i’, ‘n’, and ‘p’, the teacher can help the student build words with more advanced structures like spin and stamp. Having all introduced graphemes available when students begin a lesson helps teachers save time and ensure maximum opportunities for practice and reading growth.

To demonstrate how the preferred embodiment would be used, the following sample lesson is provided. For the purposes of this sample, note that “sound tiles” refer to phoneme manipulatives, “letter”, “letter tiles” or a named letter may refer to grapheme manipulatives, and the “large white space” refers to a flexible work area. “Today we're going to work in our phonics kits. Please pull out your kit and open it up. Give a thumbs up when you are ready. Looks like everyone is ready to go! Let's build the word cat. How many sounds do you hear in the word cat? Let's move our sound tiles one by one as we say the sounds in this word, /c/ . . . /a/ . . . /t/. I moved 3 sound tiles. Do you have 3 sound tiles on your board? Good! Let's see if we can find the graphemes that match these sounds. Does anyone know which letter represents the /c/ sound. Good! We need the letter ‘c’ to spell the /c/ sound in this word. Let's look for the letter that spells the /a/ sound next. Good! I see you found the letter ‘a’ to spell the /a/ sound. Now we have one final sound. This final sound is the /t/ sound. Does anyone know what letter spells the /t/ sound? Good! Let's all move the letter ‘t’ right under our last sound tile. Now we have a letter to represent each sound in this word. Let's blend these sounds together. We have /c/ /a/ /t/ . . . that says cat! Everyone write cat on the line on your board. Great work! Now I am going to ask you to manipulate the sounds in this word. We're going to change the final sound in this word to a /p/ sound. Does anyone know what letter spells the /p/ sound? Excellent! Let's all look for the letter ‘p’. We're going to put our letter ‘t’ away and put our letter ‘p’ under this final sound tile. Now we have a new word. Let's see if we can figure out what new word we built! Let's blend these sounds together. /c/ /a/ /p/ . . . /c/ /a/ /p/ . . . that says cap! Excellent job building the word cap. I want you to erase the word cat on your board and write the new word cap. Good job! Now we're going to make a new word. This time I am going to tell you the word and I want you to tell me which sound has changed. The new word is map. Think about the sounds in the word “map”. How many sounds do we have in “map”? Good! We still have three sounds. Do we need all of the letters we have on the board? No! We need to remove one letter. Which letter needs to be removed? Good! I don't have a /c/ sound at the beginning of my word anymore. Now I need the letter that spells /m/. Does anyone know which letter spells the /m/ sound?Great! Let's all find our ‘m’ and put it right here in the front of our word. Now we have a new word. Let's blend the sounds together to hear our new word. We've built the word map! Everyone write the new word on your board. Excellent! Now I want to show you a new letter. Today I have the letter ‘s’. It looks a little bit like a snake. Let me show you how to write the letter ‘s’. I start at the top and make a curve this way, almost like I'm making the letter ‘c’, except this time I keep going and curve back around. This is the letter ‘s’. What letter? Good! Now let's practice together. Everyone use this large white space on your board. We're going to make the letter ‘c’—very good, and now we're going to keep curving around, almost like a winding snake, good, and that makes the letter ‘s’. Excellent! It's your turn to practice writing the letter ‘s’. I have a letter ‘s’ tile to pass out to each of you. You will practice writing the letter ‘s’, while I pass these out. Remember, make a ‘c’, keep going, then curve the other way. You will work the whole time. Go! Very good! Now that we all have a tile for the letter ‘s’, I want to show you the sound it makes. The letter s spells the sound /s/. It sounds like a snake too! Can you make that sound? Very good! Right now we have the word “map” on our boards. I want to say that I have more than one map. I want to say that I have maps. To do that, I am going to have to add another sound to the end of the word. I'm going to move one of my sound tiles to the end of my word. Now I can see I need to write four sounds. Does anyone remember which letter spells the sound /s/? Good! We just learned that sound today! We need to add an ‘s’ to the end of the word to say there is more than one. Let's check our sounds . . . /m/ /a/ /p/ /s/—Do we have the right letters beneath these sound tiles to spell those sounds? Very good! We can write our new word on our board. Everyone please write the word “maps”. Excellent! We're done with our word chains for today. Please zip up your kit and place it back inside your desk.”

The lesson above would take approximately ten minutes to complete. In that time students were given the opportunity to review grapheme-phoneme relationships they had already learned, learn a new grapheme-phoneme relationship, receive explicit instruction in handwriting and spelling rules, and practice blending to decode words. Repeated exposure to word mapping accelerates growth in this phase. The more opportunities students have to practice, the better. Notice how having a phonics kit to manipulate allowed every student in the class to participate and work during the practice. The kits were ready to go at the start of the lesson and adjusted for the next day by adding a new tile.

As students progress through the graphemes in the language, they can be introduced to more spelling rules and shift towards Read and Henderson's Correct Stage for spelling. Practice expedites spelling development as it does not occur without instruction. It can be helpful to use diacritical marks to learn these rules. For example, if a student builds the word pin, they can use a breve (\check{ }) to mark that the ‘i’ in this word is making a short sound. The teacher can then show the student how the sound the letter ‘i’ represents can change by adding the letter ‘e’ to the end of the word. This changes the word to pine and the student can then change the diacritical mark to a macron, a short line above the vowel that indicates it is representing the long sound. Our kit allows teachers to use this strategy by utilizing the phoneme word building area for diacritical marking instead of phoneme manipulatives while continuing to use the graphemes manipulatives in the grapheme word building area. As students move towards even more advanced structures in words, they can use the grid to work on longer words, even words that are longer than 5 graphemes, by breaking them down into syllables and writing them in stages. In this way, this one kit meets the needs of students as they transition through several stages of reading and spelling development.

The kit was designed for students learning to read and write in English, but could easily be altered in other embodiments to work for any language with an alphabetic orthography, including, but not limited to, Spanish and French. Furthermore, it is contemplated that another embodiment may allow for the use of a stand, or a leg protruding from the outside cover, to hold an upper board up vertically so that students may more easily view and interact with features of the upper board such as the grapheme presentation area or flexible workspace area. A stand may also reduce the desktop space required for usage, which may be preferable in crowded environments or where space is limited. Other embodiments may modify or relocate elements of the preferred embodiment, such as the grapheme presentation area, phoneme presentation area, interactive word building area, blending line, writing line, phoneme manipulatives and/or grapheme manipulatives to make alternate configurations of the element arrangements including, but not limited to, mirror images, rearrangements, omissions, scaling and/or rotations. Alternate configurations of the elements themselves are contemplated including, but not limited to, mirror images, rearrangements, various spacing, extensions, reductions, scaling and/or rotations. It is also contemplated that embodiments may use a variety of colors and themes to enhance the appearance of the elements described in the preferred embodiment. Some embodiments may use boards consisting of multiple materials, such as half metal and half whiteboard. In such an example, the metal surface may house the word building and presentation areas and may exhibit ferromagnetic properties so that magnetic manipulatives stick to it, while the whiteboard area may be reserved for the writing line and possibly a flexible workspace. It is contemplated that a possible advantage may be that the magnetic manipulatives are not attracted to the whiteboard, which may help ensure the area remains available for writing, marking or drawing. In the aforementioned example, the whiteboard makes up part of the board while the metal surface makes up another part, although a wide variety of materials may be combined to make up the board as previously discussed.

What is claimed is:

1. An apparatus for literacy development, comprising:
a. a board or set of boards which, taken as a whole, comprises:
i. a grapheme building area arranged as a plurality of grapheme word building placeholders, wherein each grapheme word building place holder is perceptibly delineated,
b. a plurality of phoneme manipulatives,
c. and a plurality of grapheme manipulatives wherein,
i. at least one grapheme manipulative is a multi-letter grapheme.

2. An apparatus for literacy development, comprising:
a. a board or set of boards which, taken as a whole, comprises:
i. a phoneme building area arranged as a plurality of phoneme word building placeholders, wherein each phoneme word building place holder is perceptibly delineated,
ii. and a grapheme building area arranged as a plurality of grapheme word building placeholders, wherein each grapheme word building place holder is perceptibly delineated
b. a plurality of phoneme manipulatives,
c. and a plurality of grapheme manipulatives.

3. The apparatus of claim 2 wherein,
a. at least one board is a whiteboard, in whole or in part.

4. The apparatus of claim 2 wherein,
a. the apparatus further comprises a dedicated storage compartment used to store manipulatives that are not in use.

5. The apparatus of claim 4 wherein,
a. the storage compartment conceals all stored manipulatives.

6. The apparatus of claim 5 wherein,
a. the storage compartment is zippable with a storage zipper.

7. The apparatus of claim 2 wherein,
a. an arrangement or mechanism is provided to perceive a one-to-one mapping of each grapheme word building placeholder to an associated phoneme word building placeholder.

8. The apparatus of claim 7 wherein,
a. no grapheme word building placeholder occupies, in whole, the same area a phoneme word building placeholder.

9. The apparatus of claim 8 wherein,
a. at least one board further comprises a grapheme presentation area.

10. The apparatus of claim 9 wherein,
a. at least one board further comprises a phoneme presentation area.

11. The apparatus of claim 7 wherein,
a. the plurality of grapheme manipulatives is attachable to at least one board by magnetism or by Velcro.

12. The apparatus of claim 7 wherein,
a. the interactive word building area further comprises a blending line.

13. The apparatus of claim 7 wherein,
a. the interactive word building area further comprises a writing area.

14. The apparatus of claim 10 wherein,
a. the apparatus further comprises a closable enclosure suitable to contain at least one board, the phoneme manipulatives and the grapheme manipulatives.

15. The apparatus of claim 14 wherein,
a. the enclosure can be zipped up with an enclosing zipper.

16. The apparatus of claim 13 wherein,
a. the apparatus further comprises a writing tool suitable for whiteboards.

17. An apparatus for literacy development, comprising:
a. a first whiteboard comprising:
i. a grapheme manipulative presentation area comprising a plurality of grapheme presentation placeholders, wherein each grapheme presentation placeholder is perceptibly delineated,
b. a second whiteboard embedded in a backing material comprising:
i. a phoneme manipulative presentation area comprising a plurality of phoneme presentation placeholders, wherein each phoneme presentation placeholder is perceptibly delineated,
ii. and an interactive word building area, wherein the word building area further comprises:
1. a phoneme building area arranged as a plurality of phoneme manipulative placeholders, wherein each phoneme word building place holder is perceptibly delineated,
2. and a grapheme building area arranged as a plurality of grapheme word building placeholders, wherein each grapheme word building place holder is perceptibly delineated and an arrangement or mechanism is provided to perceive a one-to-one mapping of each grapheme word building placeholder to an associated phoneme word building placeholder,
c. a plurality of phoneme manipulatives, wherein each phoneme manipulative comprises:
i. a magnetic substrate,
d. a plurality of grapheme manipulatives, wherein each grapheme manipulative comprises:
i. a magnetic substrate,
e. a storage compartment that conceals stored manipulatives,
f. a writing tool suitable for marking whiteboards,
g. and an enclosure capable of containing the first whiteboard, the second whiteboard, the plurality of phoneme manipulatives, the plurality of grapheme manipulatives, the storage compartment and the writing tool.

18. The apparatus of 17 wherein,
a. the storage compartment is zippable with a storage zipper.

19. The apparatus of 18 wherein,
a. each grapheme manipulative of the plurality of grapheme manipulatives has a solid color with no markings or has a solid color with the markings of a grapheme of human language.

20. The apparatus of 18 wherein,
a. the first whiteboard further comprises a first flexible work area,
b. and the second whiteboard further comprises a second flexible work area.
